(19) United States
(12) Patent Application Publication
(10) Pub. No.: US 2002/0171393 A1
(43) Pub. Date: Nov. 21, 2002

(54) Intelligent charging system

(76) Inventor: Shih-Yi Huang, Taipei (TW)

Correspondence Address: BIRCH STEWART KOLASCH & BIRCH, PO BOX 747, FALLS CHURCH, VA, 22040-0747, US

(21) Appl. No.: 09/848,419

(22) Filed: May 4, 2001

(51) Int. Cl. H02J 7/00

(52) U.S. Cl. 320/106

(57) ABSTRACT

A charging system for lithium batteries, which can adjust the charging voltage during the later charging period so that the battery can be better charged. The charging system mainly includes a voltage reading unit coupled to a battery to read the voltage of the battery during the charging process, a voltage determining unit coupled to the voltage reading unit to determine the read voltage value, and a voltage adjusting unit coupled to the voltage determining unit to adjust the charging voltage on the battery according to the determined voltage.

### BACKGROUND OF THE INVENTION

1. Field of Invention

The invention relates to an intelligent charging system and, in particular, to a charging system for lithium batteries that can adjust the charging voltage on a battery during the later charging period.

2. Related Art

Batteries have become basic equipment of notebooks. The power supply duration of the battery is a key factor affecting the efficiency of the notebook computers.

The charging method for lithium ion batteries used in usual notebooks is done by converting a fixed current into a fixed voltage, which cannot fully charge the batteries very efficiently. This is because when the battery is close to fully charged, it is very possible that the charging voltage is so high that a charging protection circuit is triggered to shut down the charging power supply, resulting in unsaturated battery. This then gives a shorter battery power supply time.

### SUMMARY OF THE INVENTION

In view of the foregoing, an object of the invention is to provide an intelligent charging system particularly for lithium batteries, which can adjust the charging voltage so that the battery can be properly charged during the later charging period.

The intelligent charging system disclosed herein mainly includes:

a voltage reading unit coupled to the lithium battery to measure the voltage on the battery during the charging process;

a voltage determining unit coupled to the voltage reading unit to determine the voltage measured; and

a voltage adjusting unit coupled to the voltage determining unit to adjust the charging voltage on the battery according to the voltage determination result.

Other features and advantages of the present invention will be apparent from the following detailed description, which proceeds with reference to the accompanying drawings.

### BRIEF DESCRIPTION OF THE DRAWINGS

FIG. 1 is a system block diagram of the invention; and

FIG. 2 is a flowchart of the disclosed method.

### DETAILED DESCRIPTION OF THE INVENTION

The main purpose of the disclosed intelligent charging system is to solve the problem that batteries cannot be fully charged using the traditional methods. The main technique is to use a keyboard BIOS to read in the voltage on the battery through the DAC (Digital-to-Analogue Converter) of a keyboard controller. The voltage is monitored at all times during the charging process. When the charging process is close to being complete, the charging voltage is lowered if it is too high and is raised if it is too low. The actions of monitoring and adjusting the voltage imposed on the battery are the basic principles of the invention.

In accordance with the above principles, the intelligent charging system includes:

a voltage reading unit 31 coupled to a lithium battery 1 to measure the voltage on the battery during the charging process;

a voltage determining unit 32 coupled to the voltage reading unit 31 to determine the voltage measured; and

a voltage adjusting unit 33 coupled to the voltage determining unit 32 to adjust the charging voltage on the battery according to the voltage determination result.

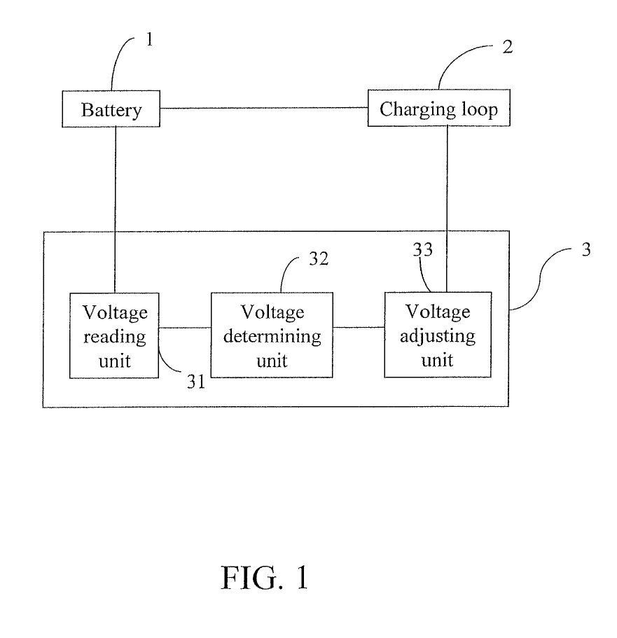

As shown in FIG. 1, the voltage reading unit uses the DAC of a keyboard controller to measure the voltage value. The voltage adjusting unit 33 also couples to the charging loop 2 of the battery 1. When the voltage value on the battery determined by the voltage determining unit 32 is too high, the voltage adjusting unit 33 lowers the charging voltage through the charging loop 2. On the other hand, if the voltage on the battery is determined to be too low, the voltage adjusting unit 33 raises the charging voltage through the charging loop 2 too.

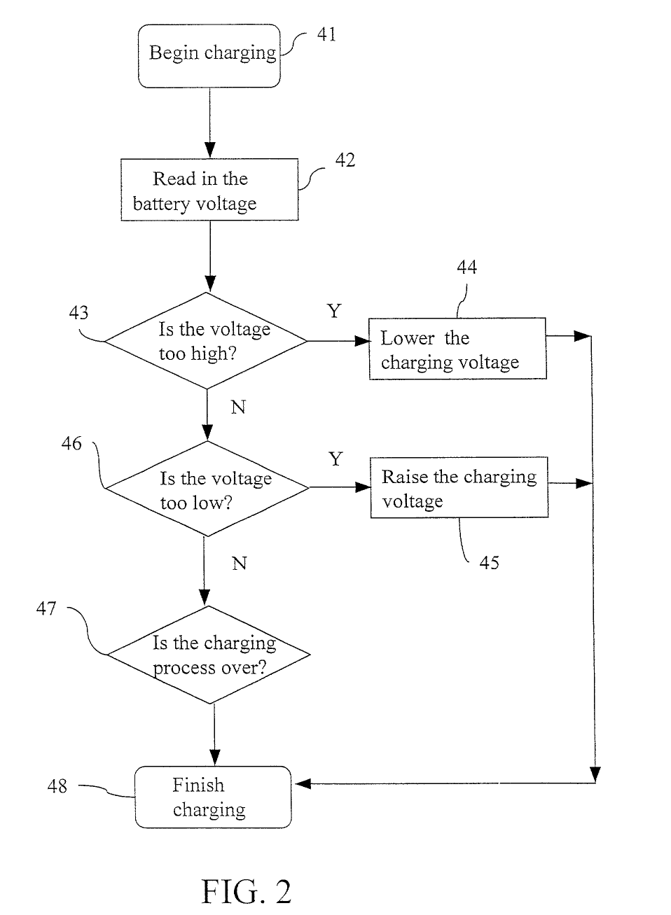

With reference to FIG. 2, when the charging process starts (step 41) the voltage on the battery is measured at all times by the DAC of a keyboard controller (step 42). The reading step is achieved with the voltage reading unit 31 of the intelligent charging system 3.

After the voltage value is obtained, the voltage determining unit 32 determines whether he voltage value is higher or lower than s standard value. The standard voltage is set to be the triggering value of the charging protection circuit of the battery. If the voltage imposed on the battery is higher than the standard value (step 43), the charging voltage is lowered (step 44). If the voltage imposed on the battery is lower than the standard value (step 45), the charging voltage is raised (step 46). This process is achieved by using the voltage adjusting unit 33 and the charging loop 2 in the intelligent charging system 3.

Effects of the Invention

According to the disclosed techniques, the intelligent charging system can automatically adjust the voltage imposed on a lithium ion battery during the later charging period so that the battery can be optimally charged to store more power for notebook computers.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An intelligent charging system for lithium batteries, which comprises:
a voltage reading unit coupled to the lithium battery to measure the voltage on the battery during the charging process;
a voltage determining unit coupled to the voltage reading unit to determine the voltage measured; and
a voltage adjusting unit coupled to the voltage determining unit to adjust the charging voltage on the battery according to the voltage determination result.

2. The system of claim 1, wherein the voltage reading unit is a DAC (Digital-to-Analogue Converter) of a keyboard controller.

3. An intelligent charging method for lithium batteries, which comprises the steps of:
reading the voltage imposed on the battery through a voltage reading unit;
comparing the voltage with the triggering voltage of the charging protection circuit for the battery; and
adjusting the charging voltage according to the comparison result.

4. The method of claim 3, wherein the step of comparing the charging voltage is achieved using a voltage determining unit.

5. The method of claim 3, wherein the step of adjusting the charging voltage of the battery lowers the charging voltage if it is higher than the triggering voltage of the charging protection circuit and raises the charging voltage if it is lower than the triggering voltage of the charging protection circuit.

6. The method of claim 5, wherein the step of adjusting the charging voltage of the battery is achieved using a voltage adjusting unit.
